(19) United States
(12) Patent Application Publication
(10) Pub. No.: US 2002/0150869 A1
(43) Pub. Date: Oct. 17, 2002

(54) Context-responsive spoken language instruction

(76) Inventor: Zeev Shpiro, Ra' anana (IL)

Correspondence Address: David A. Hall, Heller Ehrman White & McAuliffe LLP, 4350 La Jolla Village Drive, 7th Floor, San Diego, CA, 92122-1246, US

(21) Appl. No.: 10/023,521

(22) Filed: Dec. 18, 2001

Related U.S. Application Data
(60) Provisional application No. 60/256,537, filed on Dec. 18, 2000.
(60) Provisional application No. 60/256,557, filed on Dec. 18, 2000.
(60) Provisional application No. 60/256,558, filed on Dec. 18, 2000.
(60) Provisional application No. 60/256,560, filed on Dec. 18, 2000.

(51) Int. Cl. G09B 19/00

(52) U.S. Cl. 434/156

(57) ABSTRACT

A language skills training system supports interactive dialogue in which a spoken user input is recorded into a processing device and then the spoken user input is analyzed for multiple phonetic criteria, wherein at least one of the phonetic criteria comprises intonation, stress, or rhythm. The system includes multiple context-based practice exercises and multiple problem-based exercises, such that each problem-based practice exercise is interactively linked to at least one of the context-based practice exercises, and relates to skills being practiced in the context-based practice exercises to which it is linked. Each of the context-based practice exercise tests user skills that are being taught in the linked problem-based exercises. If user responses indicate that the user would benefit from extra practice in particular types of language skills, then the user will be routed to one or more of the practice problem sets that involve the language skill in which the user is deficient. Upon successful completion of the problem sets, the user is returned to the exercise sequence.

### REFERENCE TO PRIORITY DOCUMENT

This application claims priority of co-pending U.S. Provisional Patent Application Serial No. 60/256,537 entitled “Context Responsive Spoken Language Instruction” by Z. Shpiro, filed Dec. 18, 2000. Priority of the filing date of Dec. 18, 2000 is hereby claimed, and the disclosure of the Provisional Patent Application is hereby incorporated by reference.

### BACKGROUND OF THE INVENTION

1. Field of the Invention

This invention relates generally to educational systems and, more particularly, to computer assisted spoken language instruction.

2. Description of the Related Art

Computers are being used more and more to assist in educational efforts. This is especially true in language skills instruction to teach vocabulary, grammar, comprehension, and pronunciation. Typical language skills instructional materials include printed matter, audio and video cassettes, multimedia presentations, and Internet-based training. Most Internet applications, however, do not add significant new features, but merely represent the conversion of other materials to a computer-accessible representation.

Some computer-assisted instruction provides spoken language practice and feedback on desired pronunciation. Most of the practice and feedback is guidance on a target word response and a target pronunciation, wherein the user mimics a spoken phrase or sound in a target language. For example, teaching vocabulary consists of identifying words, speaking the words by repetition, and practicing proper pronunciation. It is generally hoped that the student, by sheer repetition, will become skilled in the proper pronunciation, including proper stress, rhythm, and intonation of words and sounds in the target language.

Students can become discouraged and frustrated because a computer system may not be able to understand the word they are saying and therefore cannot provide instruction, or they may become frustrated because the computer system may not provide meaningful feedback. Often, students spend too much time repeating exercises and lessons. Research efforts are directed to how systems may better recognize and identify the word or phrase the student is attempting to say, and keep track of student's progress through a lesson plan. For example, U.S. Pat. No. 5,487,671 to Shpiro et al. describes a language instruction system.

Conventional systems do not provide feedback tailored to a user's current problem, such as what he or she should do differently to pronounce words better. The feedback and instruction is often unrelated to the student's response or to the context in which the student's performance is produced. Some conventional computer systems are directed to better determination of user responses and better evaluation of responses and tracking of a student's progress.

From the discussion above, it should be apparent that there is a need for spoken language instruction that is responsive to difficulties being experienced by an individual student, and that provides meaningful feedback that includes identification of the error being made by the student, and that provides a lesson plan that is more dynamic and tailored to the problems encountered by the student. The present invention fulfills this need.

### SUMMARY OF THE INVENTION

The present invention supports interactive dialogue in which a spoken user input is recorded into a presentation processing device and then the spoken user input is analyzed for multiple phonetic criteria, wherein at least one of the phonetic criteria comprises intonation, stress, or rhythm. A language training system constructed in accordance with the present invention can support an interactive dialogue and can provide an interactive system that includes multiple context-based practice exercises and multiple problem-based exercises, such that each problem-based practice exercise is interactively linked to at least one of the context-based practice exercises, and relates to skills being practiced in the context-based practice exercises to which it is linked, and wherein each context-based practice exercise tests user skills that are being taught in the linked problem-based exercises. Thus, if the user responses indicate that the user would benefit from extra practice in particular types of language skills, then the user will be routed to one or more practice problem sets that involve the language skill in which the user is deficient. Upon successful completion of the problem sets, the user is returned to the exercise sequence, either to the same exercise, prior to the problem set, or to the next exercise in the lesson plan sequence.

User inputs may be received in conjunction with a user who is viewing written materials, such as instructional texts, at the presentation device. As the user works through the written materials, the user will provide various inputs to the presentation device, which may comprise a computer system. The inputs may be prompted by exercises in the written materials or the inputs may be requests for supplemental information, such as requests for dictionary definitions of words. Thus, the written materials may include readers, textbooks, and workbooks, and will provide instruction in particular language skills areas. In such a case, the user inputs may indicate particular language skills deficiencies on which the user may require further practice. The system will preferably duplicate the written materials being viewed by the user, so that a concordance between the computer materials and the written materials may be established. The user input may be presented through a navigation interface with which the user may specify absolute and relative movement through a display of information from among information sources such as an electronic dictionary, language reader texts, vocabulary training, and traveler's aid materials.

A system constructed in accordance with the invention provides continuous context examination and may include components that provide any one or all of the context-based learning instruction features, including multi-level language lesson plans, targeted practice on phoneme stress or pronunciation or intonation or rhythm language pronunciation, on-line supplemented information keyed to written materials such as readers, textbooks, and workbooks, requests for dictionary definitions of words, or commands for navigation through language materials.

Other features and advantages of the present invention should be apparent from the following description of the preferred embodiment, which illustrates, by way of example, the principles of the invention.

### BRIEF DESCRIPTION OF THE DRAWINGS

FIG. 1 is a flow diagram that illustrates the processing performed by a computer system to provide a language training system in accordance with the present invention.

FIG. 2 is a block diagram representation of an Internet-based configuration for a language training system that performs the processing illustrated in FIG. 1.

FIG. 3A and FIG. 3B show representations of a user making use of a language training system constructed in accordance with the present invention.

FIG. 4 is a representation of the display screen produced by the language training system illustrated in FIG. 2.

FIG. 5 is a flow diagram representation of the operations performed in presenting a lesson to a user of the system illustrated in FIG. 1.

FIG. 6 is a flow diagram representation of the language training system, indicating that a user moves between a sequence of exercises and, if needed, is routed to one or more problem sets.

FIG. 7A and FIG. 7B are flow diagrams that together illustrate the processing executed by the language training system to perform context based language instruction with language reader materials.

FIG. 8 is a graphical representation of the user computer illustrated in FIG. 2 being used for language instruction.

FIG. 9, FIG. 10, and FIG. 11 are illustrations of a user display viewed by the user illustrated in FIG. 8.

FIG. 12 is a flow diagram that illustrates the processing executed by the FIG. 8 computer system to perform context based language instruction with language work book materials.

FIG. 13 and FIG. 14 are graphical representations of the user computer illustrated in FIG. 8 being used for language instruction.

FIG. 15A and FIG. 15B are flow diagrams that illustrate the operation of the language skills training system illustrated in FIG. 8 to provide an assessment tool.

FIG. 16 illustrates the sequence of operations performed by the assessment tool of the language skills training system.

FIG. 17 and FIG. 18 illustrate the language skills learning system being used by two users who are communicating over a computer network such as the Internet.

FIG. 19 shows the language skills training system being used as a conversation aid with telephone communication.

FIG. 20 shows the language skills training system being operated by a user as a conversation aid, where the second dialogue participant is a computer.

FIG. 21A and FIG. 21B illustrate a sequence of dialogue between a user and a language skills training system as a conversation aid.

### DETAILED DESCRIPTION

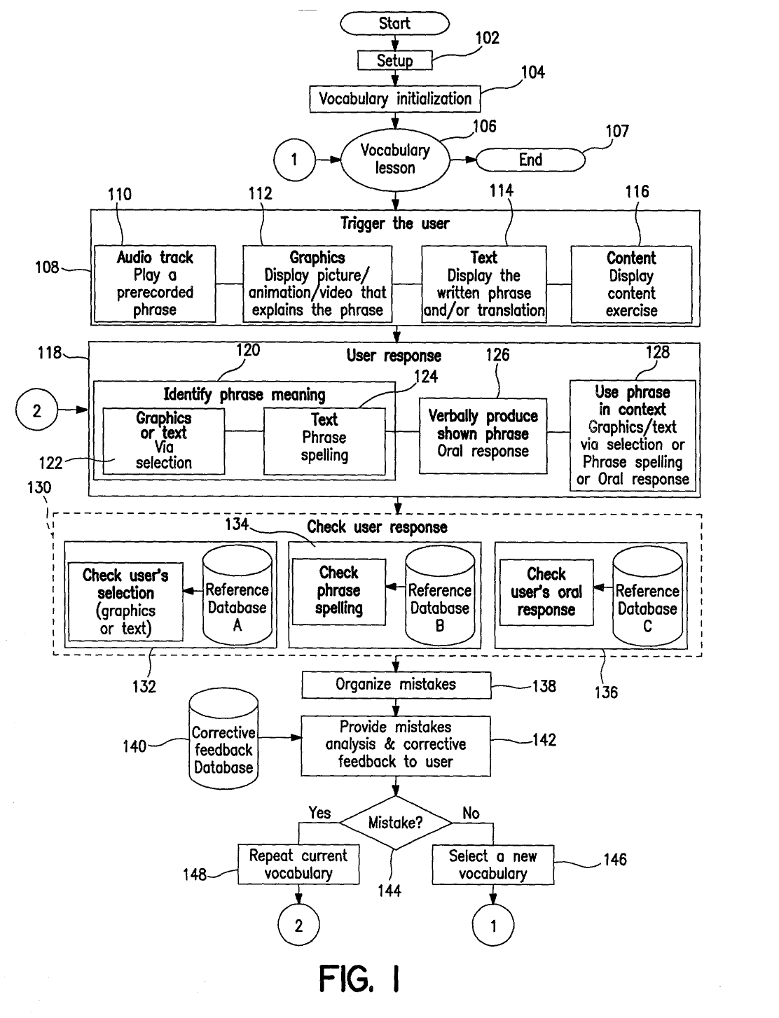

FIG. 1 is a flow diagram that illustrates the processing performed by a presentation system to provide a language training system in accordance with the present invention. As described further below, the presentation system may comprise, for example, a computer processing system in which client machines communicate with servers. In the first operation, indicated by the flow diagram box numbered 102, a user sets up the system, such as by providing user identification information, target language, native language, and the like. User reference databases may be consulted by the system to verify such user information. The computer-implemented processing includes voice communication between the user and the computer system, as described further below. Therefore, the user also performs a vocabulary initialization step, indicated at box 104, comprising a voice calibration process that is common with conventional computer voice recognition systems.

At the flow diagram box numbered 106, the user selects a lesson for study, such as a vocabulary lesson. If the user is at the end of a lesson plan, then the computer operation ends, as indicated at box 107. If the user proceeds with a lesson, then the user is triggered to provide an input response by an audio track presentation, a graphics display on the user computer, a text display, or a combination of audio, graphics, and text information. The triggering operation is indicated in FIG. 1 by the flow diagram box numbered 108.

To trigger the user, the system may cause the playing of an audio track, in which a prerecorded phrase is played through audio equipment of the computer system, as indicated by the flow diagram box numbered 110. The user will be expected to repeat the phrase into the computer as part of the lesson plan. The system may trigger the user by producing a graphics display or audiovisual display comprising an illustration, animation, or video clip that presents or explains a phrase to be repeated by the user, as indicated by the box 112. At box 114, the system may display written text that shows the phrase to be repeated, or shows a translation of the phrase, or shows both. As indicated at the box 116, the trigger to the user may include a content exercise displayed to the user, to prompt the user for the response. Thus, one or more, or all, of the audio, graphic, and audiovisual presentations may be provided to the user.

After the user has been triggered to provide a response input, the computer system receives the user response at the box numbered 118. The user may be asked to identify a phrase meaning, as indicated at box 120. The phrase meaning identification may occur by user selection of graphics or text (box 122) or by providing text input for a phrase spelling (box 124). The user may be asked to produce a verbal input that corresponds to a phrase presented as the trigger. The oral user response will be received by the computer system, as indicated by the flow diagram box numbered 126. Alternatively, the user may be asked to use the trigger phrase in proper context, indicated at the flow diagram box numbered 128, such as by selected a computer-displayed graphics or text presentation, by providing a proper spelling of a phrase through text input, or by providing an oral response.

After the user's response is received, the computer system checks the response at the flow diagram box numbered 130. The user's response will be checked by comparing the response to a graphics reference database that supports graphics comparison 132, or by comparing it to a text phrase spelling reference database that supports a spelling check 134, or by comparing it to an audio vocal response reference database that supports checking the user's vocal response 136.

Any errors in the user's response are detected and organized into a format that lists and identifies the nature of the error, indicated at the flow diagram box numbered 138. For example, the format may list stress errors first, followed by rhythm errors. The computer system then retrieves corrective feedback from a correction database 140 and provides an error analysis and corrective feedback to the user at the box numbered 142. At the decision box numbered 144, the system determines if the user has responded successfully, providing a correct and acceptable response. If the user response did not include any mistakes, a negative outcome at box 144, then no corrective feedback is necessary, and the user will be permitted to move to the next exercise at box 146, such as a new vocabulary lesson, returning to lesson start at box 106. If the user response included one or more mistakes, an affirmative response at the decision box 144, then the computer system repeats the current vocabulary exercise at box 148, requesting a response from the user and returning to the user response processing at box 118.

As described further below, the instructional process of triggering the user 108, receiving a user response 118, checking the user response for errors 130, and providing corrective feedback 142 while looping through instructional material 106 examines a user input context to determine an appropriate computer system response. The response may include, for example, lessons, or navigation commands, or supplemental information to user written materials. In addition, the instructional process may be provided in conjunction with a multi-level spoken response analysis scheme that moves the user between a lesson plan level having sequential exercises and a practice level having problem sets that provide practice on language skills in need of improvement by the user. Other features will also be described, in greater detail below.

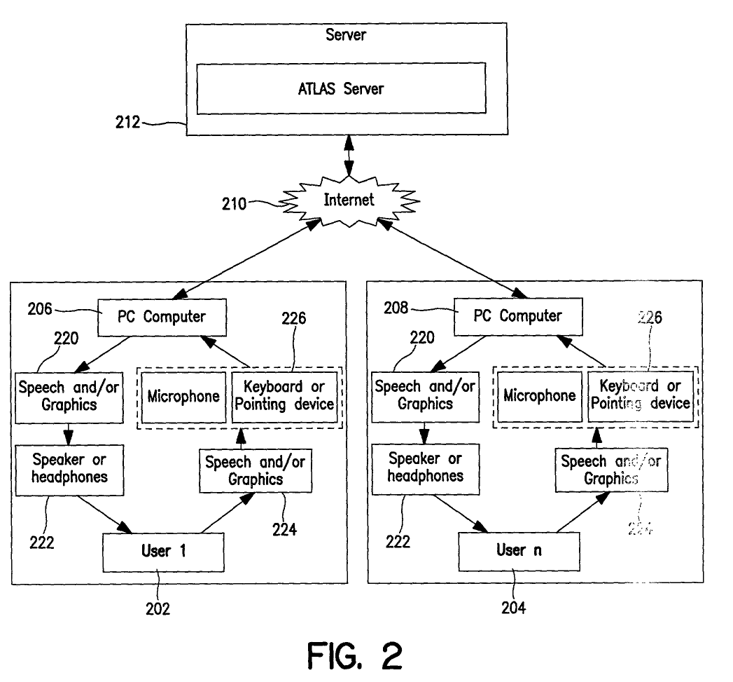

A computer system to implement the processing illustrated in FIG. 1 preferably includes one or more client devices connected over a network to a server computer. An exemplary computer system 200 is depicted in FIG. 2, which shows two workstation users 202, 204 at respective client computers 206, 208 that communicate over a network 210 to a server computer 212. The network 210 may comprise any network over which processors may communicate, such as the Internet. Thus, the computer system 200 can accommodate multiple simultaneous users. The client devices may comprise a variety of processor-based devices, including conventional personal computers (PCs), personal digital assistants (PDAs), network appliances, and the like. The client devices receive spoken input responses from the users and convert the responses to a digital representation. The server computer 212 receives the converted user responses and functions as a response analyzer, serving as an interface to the user response processing illustrated in FIG. 1. Alternatively, all of the system processing shown in FIG. 1 may be provided through a single computer, in which case the client and server functions may be performed by different software processes executing in the same computer.

It should be understood that, in FIG. 2 and in all the drawings herein, like reference numerals refer to like components that are illustrated in the drawings.

A computer 206, 208 of the context-based instructional learning system constructed in accordance with the present invention can produce speech and/or visual graphics or text information 220 to the respective computer user 202, 204. The computers may provide speech or other audio information to a user through speaker or headphone equipment 222 and may receive speech and/or graphics or text information 224 from the user through an input device 226, such as a microphone and/or a keyboard or pointing device (such as a display mouse). The server computer 212 will typically have similar user interface capabilities for an operator, but is primarily used for processing user inputs and delivering lesson content and corrective feedback. Thus, the reference databases used in the processing described in conjunction with FIG. 1 at box 102 (there is no reference database at 102) and 130 are preferably maintained at the server computer 212 in a distributed processing arrangement that makes more efficient use of computing resources.

The computers 206, 208, 212 will include associated components or subsystems for operation of systems described above. For example, the computers will include appropriate graphics display cards and graphics processors for display of the graphics 220, and the computers will include a speech recognition engine to convert user speech received at the input microphone 226 into a digital representation, using techniques known in the art. The computers will also include an appropriate sound processor, for reproduction of audio data received by the computer.

The operation of the system may depend on the system configuration. For example, if the system is implemented in a client-server environment as illustrated in FIG. 2, then the display of information at the client machines may depend on the operating capability of the client machines. Thus, if the client machines comprise computer workstations, then the audio content of a lesson may be transferred in full. If the client machines are devices with relatively low processing and storage capacity, or if the server connection does not have sufficient bandwidth, then the audio content may be transferred from the server in small segments, so that the complete audio track is never completely resident on the client machines. In addition, the video track may be transferred according to the client-server connection bandwidth. Thus, the video track may be displayed in a different quality (such as varying in display frames per second) and display window size (such as differing resolution) based on the server client communication channel bandwidth. For example, the display may be provided at a rate of one frame per minute, with a 100-pixel by 120-pixel window when a communications channel having 28.8 Kbps capacity is available, and may be adjusted by the server to provide 12 display frames per second at a 240-pixel by 320-pixel window when an broad-band (e.g. ISDN) communications channel is available.

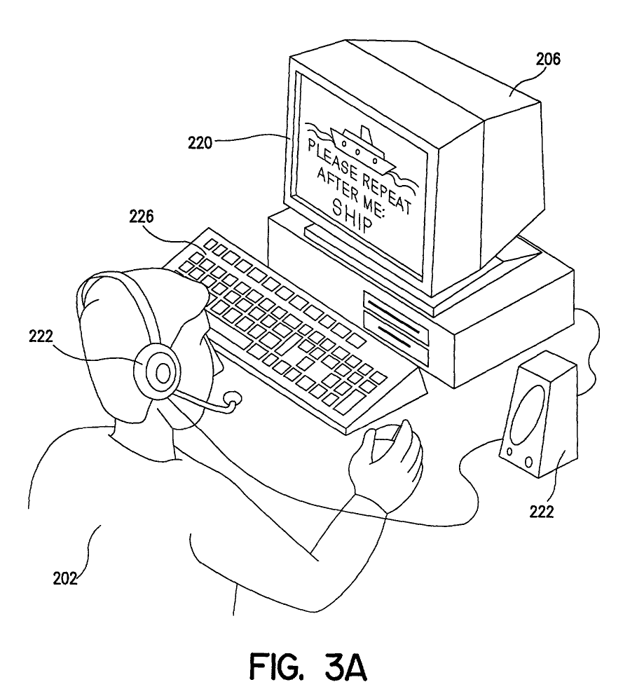

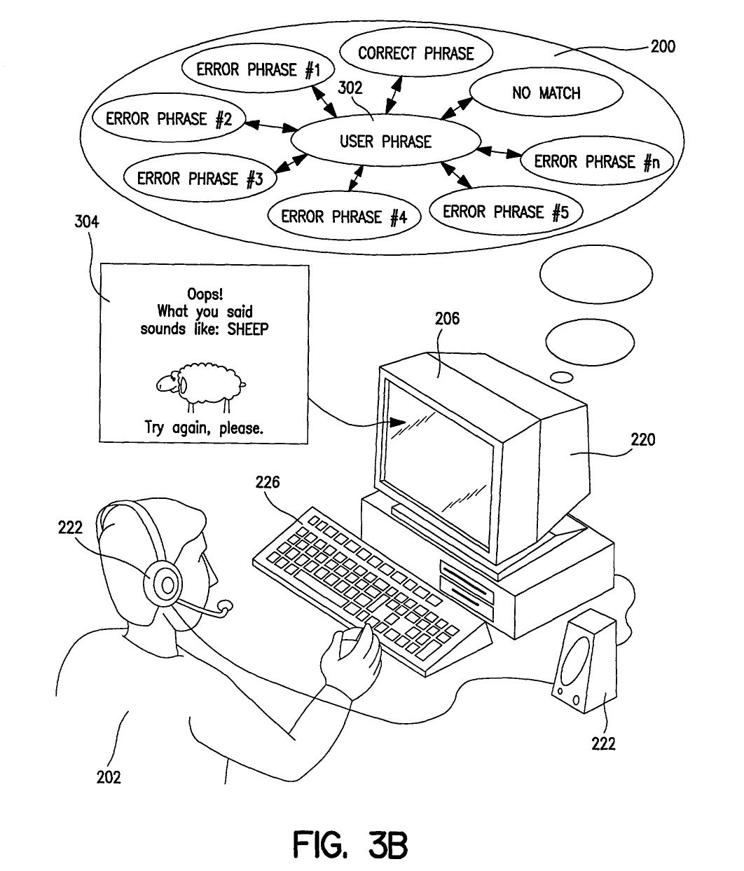

FIG. 3A and FIG. 3B show representations of a user 202 making use of a personal computer (PC) workstation 206 of the system 200. FIG. 3A shows the user 202 viewing a graphics display 220 of the client computer 206, listening over a headset 222 and providing speech or graphics input 224 to the computer through the input device 226, such as by speaking into a microphone, entering text at a keyboard, or operating a pointing device. The computer display shows a graphic of a ship and a text phrase corresponding to the audio presentation: “Please repeat after me: ship.” FIG. 3B graphically illustrates the user response being received and analyzed for correctness. FIG. 3B shows that the computer system 200 will check and compare the received response against the reference databases to identify the phrase closest to the received response 302 and then will provide corrective feedback 304 appropriate to any mistake identified in the user's response. If the computer system cannot match the user's response to any entry from the reference databases, a “no match” condition, then the computer system will ask the user to repeat the response.

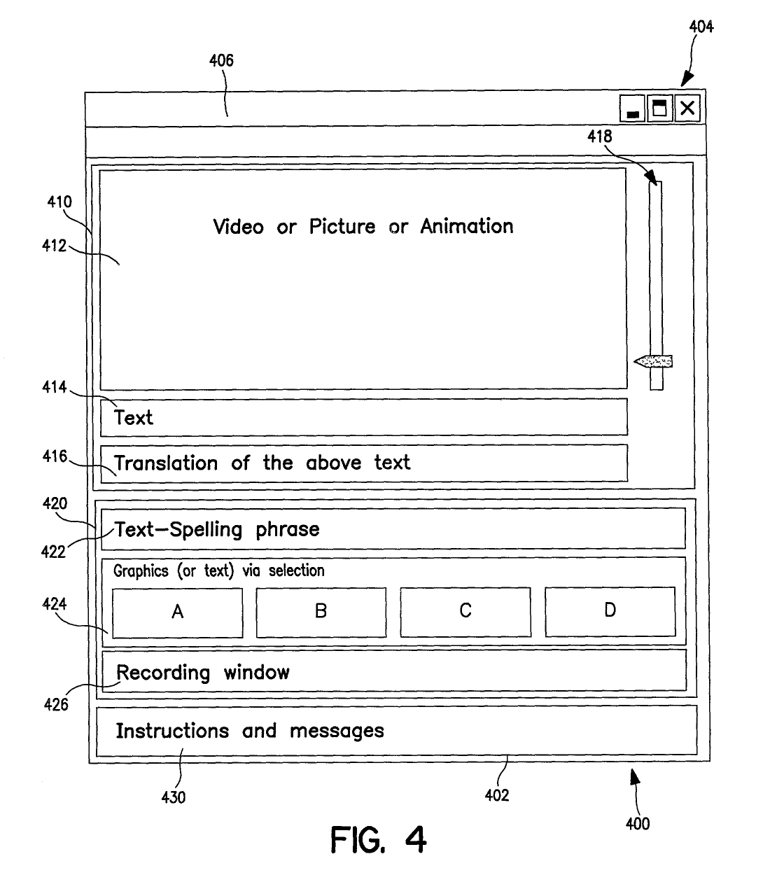

FIG. 4 is a representation of a window display 400 produced by the computer system at a display screen of a client computer. In the preferred embodiment, the system includes personal computers and provides the context-responsive learning instruction through a graphical user interface, such as the interface provided through the operating systems “Windows 2000” by Microsoft Corporation of Redmond, Wash., USA and “Macintosh OS” by Apple Computer, Inc. of Cupertino, Calif., USA. Therefore, the window display 400 includes typical window interface artifacts, such as a window frame 402 with window sizing icons 404 and a title bar 406.

FIG. 4 shows that a working area 410 of the window display 400 includes a graphical window 412 for the display of video, picture, or animation, a text window 414 that contains a text version or description of the graphical screen display, and a translation window 416 that contains a translation of the text display. The text window 414 contains text in the target language, while the translation window 416 contains text in a selected language, such as the user's native language. In the preferred embodiment, the user can alter the level of the exercise being presented by adjusting the difficulties scale 418 at the right of the working area 410. The difficulties scale is a graphical slider that determines whether or not displayed text 414 will be translated into the user's native language and shown to the user in the translation window 416. Lower levels of difficulty will allow for display of the translation, to assist the user. The user may respond to the exercise in a response area 420 of the window. The user's response may comprise text entered by the user in a user text window 422, where text entered by a user on a keyboard will be displayed. The system may, if appropriate, show alternative responses to the user in a user selection window 424. The FIG. 4 illustration shows four selections A, B, C, and D. The user will select one of the alternatives, using the keyboard and/or display mouse of the user computer. The user also may record a spoken answer, using a recording window 426. The recording window preferably shows the user's recording progress, such as by showing the text equivalent of the received user speech, as generated by the system speech recognition engine. The user receives instructions and messages from the system in a user window 430 at the bottom of the display 400.

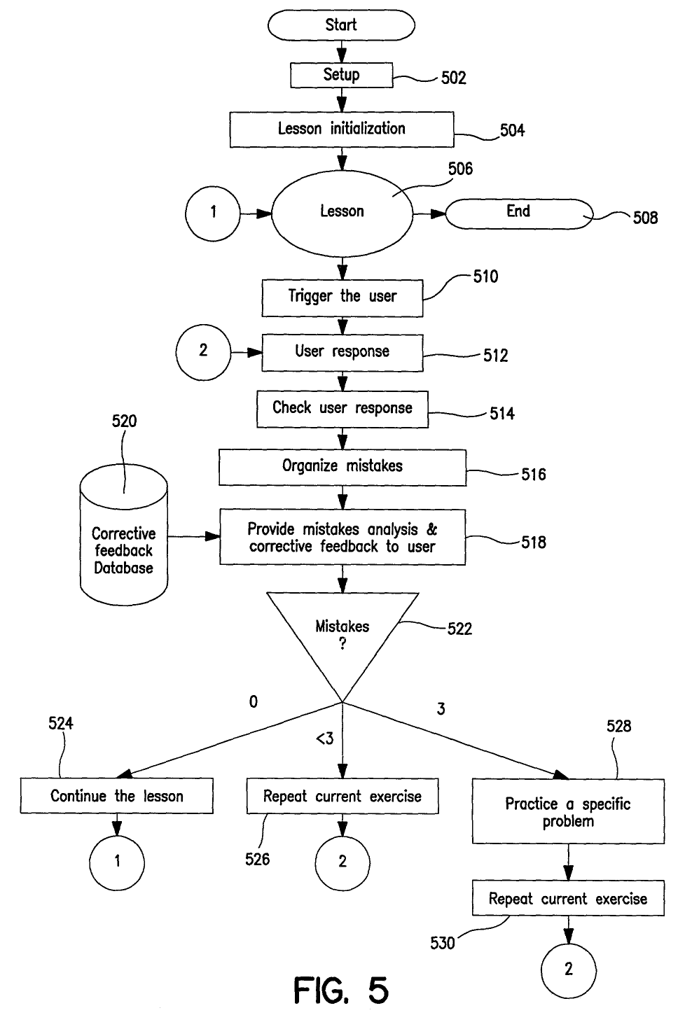

FIG. 5 is a flow diagram representation of the processing executed by the system to provide a lesson exercise to a user of the system illustrated in FIG. 1. In a setup operation, the user sets up the system, such as by entering identification information and selecting system operation parameters. The setup operation is indicated in FIG. 5 by the flow diagram box numbered 502. In the next operation, box 504, the lesson exercise is initialized, such as by setting operating parameters (including error counts and the like) to zero. The user begins the lesson at box 506. If the user has completed all exercises in a lesson plan, then no more exercises remain for the user, and processing ends at box 508. If an exercise remains in the lesson plan or study module, it is presented to the user, and the user may be presented with a prompt at box 510. The prompt will comprise, for example, a question or request for user input in the user window 430 (shown in FIG. 4).

At box 512, the user responds to the exercise. As noted above, the response may comprise a user speech input, selection from among alternative choices, or entry of alphanumeric text. At box 514, the user's response is checked and mistakes in the response, if any, are organized by the system (indicated at box 516). Organizing the mistakes may include processing the user's response and determining a hierarchy or tabulation of multiple mistakes. In the case of a spoken response, for example, the user may speak words that are incorrect, and may also improperly pronounce those words in the target language. The system preferably identifies both types of mistakes. In vocabulary training, for example, a word or group of words may be taught for appropriate user identification of the word, use in context, verbal production or pronunciation, and spelling. All these aspects of the user's responses must be checked and organized for further system action.

After the user response is processed and mistakes are organized, the system provides the user with a mistakes analysis and corrective feedback. This processing is represented by the flow diagram box numbered 518. The system preferably provides the information 518 by retrieving it from a corrective feedback database, indicated at box 520. The corrective feedback database provides the user with explanations and methods to correct his errors. Next, at the decision box 522, the system takes appropriate action in accordance with the user mistakes. If the user has not made any errors, indicated by the “0” branch from the decision box, then at box 524 the user will proceed to the next exercise, returning to the lesson box 506. If the user has made less than a predetermined number of errors, then the user will be given the opportunity to repeat the exercise at box 526. FIG. 5 indicates the predetermined number of errors with the “<3” branch from the decision box, but it should be understood that the number of errors will be pre-set, preferably by the application, or by the user. If the user is to repeat the exercise, then system operation returns to request the user's response at box 512.

If the user has made more than the predetermined number of errors, indicated by the “3” branch from the decision box 522, then the system will practice the specific problem with the user and will repeat the exercise in which the errors occurred. The practice operation (box 528) may include additional problem exercises and practice drills, as described further below. After the additional practice is completed, the user will repeat the current exercise, in which the excessive errors occurred. This operation is indicated by the flow diagram box numbered 530. System operation then returns to the lesson box 512 for entry of the user response. Only when the user has answered the exercise correctly, with no more than the required number of errors, will the user be able to continue to the next exercise in the lesson.

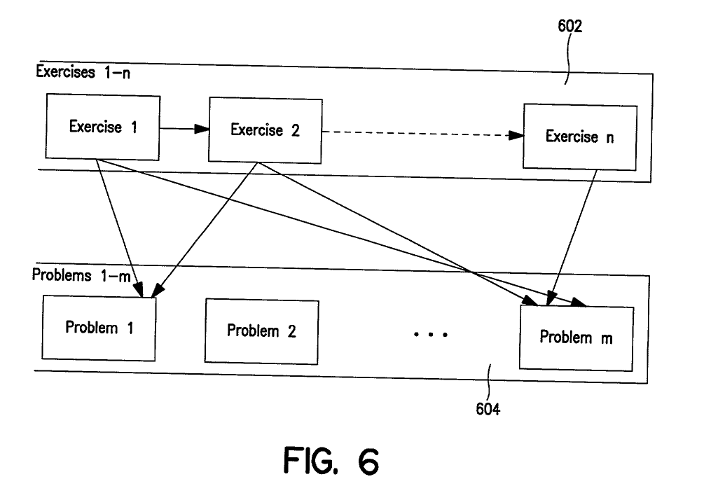

FIG. 6 is a graphical representation of the language training system operation, indicating that a user moves between a sequence of exercises and, if needed, is routed to one or more problem sets. As noted above, in the case of excessive errors in a lesson, the user will be given extra practice. As represented in FIG. 6, this type of operation by the system provides a two-level, context-based response to user errors, in which a first level 602 of primary, context-based practice exercises are first presented to the user, and then a second level 604 of one or more problem-based exercises are presented to the user for additional skills training. The user will be directed to the second level, indicated by the connecting arrows, if the number of errors from the first level indicates that additional practice in a skills area is appropriate. In addition, the system may permit the user to select problem-based exercises for additional practice. Thus, both mandatory and optional problem-based skills practice exercises may be supported.

The context-based exercises 602 will elicit answers that indicate the user's ability to use words from the target language in the appropriate context. The problem-based exercises 604, however, will provide practice with particular skills that the context-based exercises are attempting to teach. For example, a set of context-based exercises may drill the user in vocabulary words of a particular subject matter, such as tourist travel and sight-seeing. The user's spoken responses, however, may indicate that the user has a problem with pronouncing particular sounds (such as “r” or “th”) in the target language. The system will preferably detect this condition by analysis of the user's speech samples. In that case, the system operation will direct the user to problem-based exercises that will give the user additional practice (such as drills in pronouncing “r” or “th” sounds). Each context-based exercise will elicit different user responses, and therefore each contextbased exercise will be associated with a different set of potential problem-based exercises. Thus, each problem-based practice exercise will be interactively linked to at least one of the context-based practice exercises, and will relate to skills being practiced in the context-based practice exercises to which it is linked. Likewise, each context-based practice exercise will test user skills that are being taught in the linked problem-based exercises. The interactive linking will occur automatically, in accordance with box 530, so that when the user completes an exercise 602 with an excessive number of errors, the system will display a message in the user window 430 (FIG. 4) indicating that the user is being taken to skills training, and then the system will begin presentation of a selected one of the problem-based exercises 604.

It should be noted that linking may occur, not only between the context-based exercises and the problem-based exercises, but interactive linking may also occur from external sources to the FIG. 6 exercises. For example, the FIG. 6 exercises, and the operation illustrated in FIG. 1, may be implemented via an Internet site, for interaction with users who come to the Internet site through a Web browser application. The users may come to the site as a result of failing an input request at another site. The third party site, for example, may form a contractual relationship with a language skills Web site operator so that users of the third party site who cannot provide correct or intelligible responses to questions may be linked or re-directed to a language skills Web site provided in accordance with the present invention. The third party site may be a language skills site as well, or it may be any other site that requests input from user/visitors. For example, many different Web sites may want to use speaker recognition for security access reasons. If site visitors cannot properly pronounce words, then they may not be recognized and authorized, even though they are legitimate users of the site services. The present invention permits such third party sites to automatically direct persons from their site to a language skills training Web site such as described in this document.

Thus, in the context-based exercises and accompanying training, each user response is analyzed according to multiple criteria, checking for problems in skills such as pronunciation, syllable stress, and speaking rhythm. In the problem-based exercises and accompanying training, each user repetition is analyzed for the specific problem being taught. It should be noted that conventional skills training systems are typically problem-oriented rather than skills-oriented. A language skills system provided in accordance with the present invention will provide a context-oriented application in which access to problem-based exercises is independently achieved and directed at a specific problem, whereas in conventional problem-oriented training the access to exercises is sequential, such that exercises are completed in sequence, the skills in later exercises building on the skills learned in earlier exercises.

For example, in a vocabulary training product in accordance with the present invention, the word selection for study is such that all likely problems for the student are covered in the selected group of vocabulary phrases. A “Picture dictionary” is one example of a context-oriented product that may be provided in accordance with the present invention. In a conventional problem-oriented product, such as a pronunciation book, the user must perform all exercises in sequence, unless the user passes a preliminary assessment test prior to study or prior to each exercise, whereas in a context-oriented application according to the invention, only failure in a specific skill area triggers additional problem-based exercises for the user. Thus, unlike conventional applications where user performance is tested whenever the user enters or completes an assignment, the context-oriented system described herein includes continuous testing (and problem referral) during the current exercise.

Skills training products that are provided in accordance with the present invention will have the context-oriented construction described above. For example, in the case of language skills training, each product will be optimized or adapted to suit a particular target language, the user's native language, the user's culture (which sometimes may be derived from the native language), the user's age group, the user's gender, and the user's language knowledge level. The user's age is a significant factor that is preferably used to determine the graphics and content of the product. For example teaching a specific sound such as “TH” will be accomplished using different words for a first-grade student who is familiar with only 150 words as compared to an adult who is familiar with 4,000 or more words, where both users are looking to improve the production of the same sound.

In general, language skills training will be implemented along four aspects: sound; word; phrases and sentences; and text. Therefore, a typical system includes, for each level of instruction, selection of the sound/word/phrase/text being trained or studied, and system triggering for user response (triggering is defined as anything that stimulates the user to produce the expected response). The triggering can be performed in each of several ways or as a combination of several ways, including text, graphics, and audio (e.g. the word or sound indicating the word as an animal sound, etc.). The response can be produced in either of several ways or in a combination of ways, including text, graphics via selection, and voice response. The voice response can be analyzed for pronunciation, stress, rhythm, intonation, grammar (in case of more than one word), and comprehension. A text response can be analyzed for grammar, spelling, and comprehension. A user graphic selection also can be analyzed for grammar, spelling, and comprehension. Examples of these features are, for English language sounds: p (as in pen), b (as in baby); for words: cow, bird, cat, etc.; for phrases: two cows, black bird, three running horses, etc.; for sentences: “John is eating” , etc.; and for text: “. . in the morning. . .”

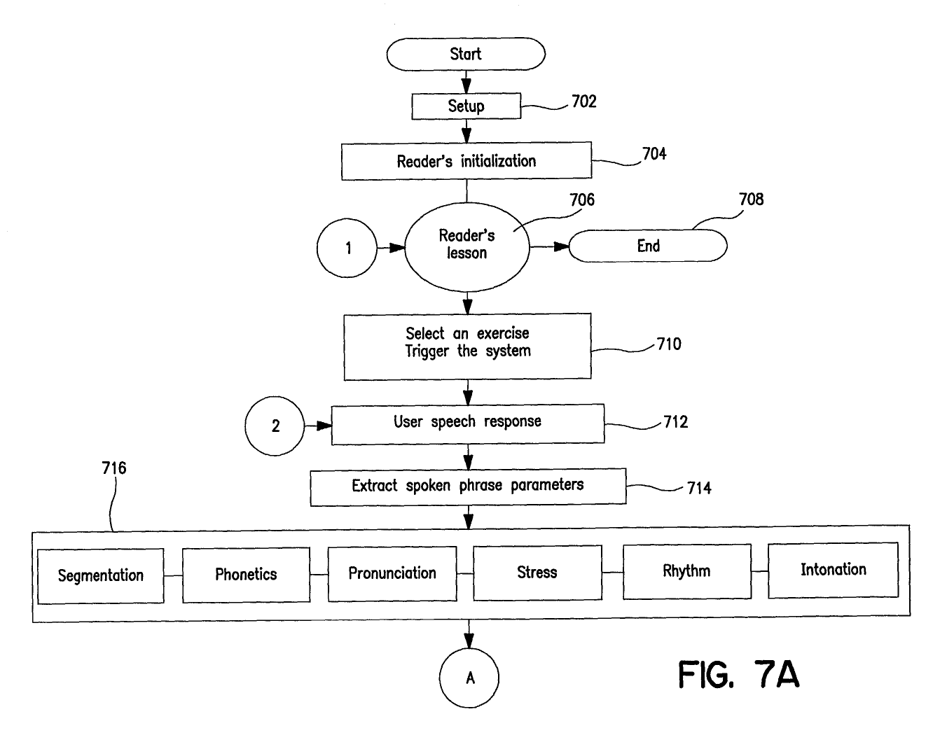

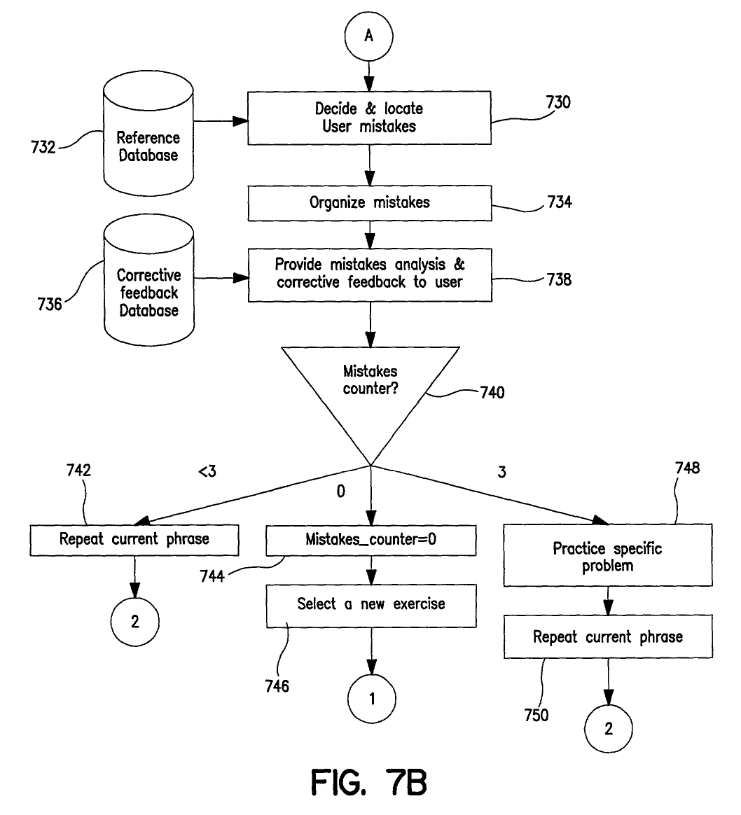

One type of language training product that may be provided in accordance with the present invention is a language reader. The language reader may be provided as an electronic publication, such as an “electronic book” or reader or workbook whose contents are viewed through a presentation device such as a computer display, personal digital assistant (PDA), pager, or Web-enabled wireless telephone. The language training system, comprising the presentation device with reader, then provides the fuctionality described herein. FIG. 7 is a flow diagram that illustrates the processing executed by the presentation device to perform context based language instruction with language reader materials in accordance with the present invention.

FIG. 7A and FIG. 7B are flow diagrams that together illustrate the processing executed by the language training system to perform context based language instruction with language reader materials. FIG. 7A shows that processing begins with a user setup operation, indicated by the flow diagram box numbered 702. User options and identification may occur during this operation. Next, at box 704, the reader software is initialized. Next, at the flow diagram box numbered 706, the system begins the lesson delivery. If there are no more lessons to be delivered to the user, such as if the user has completed all the exercises in a lesson, then the system ends the lesson processing at box 708. If additional exercises remain to be completed, then the system continues with presenting exercises to the user. At box 710, the system selects an exercise and triggers the system by presenting a question or other request or prompt to the user for a spoken response. Next, at the flow diagram box numbered 712, the user provides the spoken response.

At box 714, the user response is examined and speech parameters of the user speech are extracted. As illustrated in box 716, the user's speech is analyzed simultaneously for segmentation, phonetics, pronunciation, stress, rhythm, and intonation. Segmentation refers to parsing the user's speech into phonemes, or units of sound. The segmentation may divide the user's spoken response into a more granular level than syllables of speech. For example, the one-syllable English word “and” may be segmented into two sounds, a relatively long “an” sound and a short “duh” sound. Phonetics organizes the user's spoken response into recognizable word sounds of the target language. For example, “and” may comprise one phonetic sound, from which English language words such as “band”, “stand”, and “grand” are formed. The pronunciation analysis of box 716 involves identifying the user's pronunciation of phonetic sounds in the target language. The stress analysis involves an examination of the differing relative volume levels that the user may impart to different phonetic sounds that make up words in the user's spoken response. For example, in the English word “apple”, the first syllable is stressed, or accented, more than the second syllable. The rhythm analysis of box 716 involves identification of timing between phonetic sounds or syllables of the user's response. Taking the previous example of the word “apple”, for example, the first syllable typically takes more time to say than the second syllable. Finally, intonation refers to detecting changes in pitch in the user's response. This completes the processing illustrated in FIG. 7A.

After the user's spoken response has been parsed into identifiable sounds, phonetics, and words, the response is checked for user mistakes at box 730 of FIG. 7B by comparing the user's spoken response against a reference database at box 732 and the mistakes in the user's response, if any, are identified, located, and organized by the system at box 734. The system provides not only the correct response, but also provides the user with explanations and methods by which to correct his or her spoken errors. As indicated by the flow diagram box numbered 736, the system retrieves corrective explanations from a corrective feedback database and then delivers any such explanations at box 738. Next, the system makes a processing decision in accordance with the number of errors identified in the user's response, if any. At box 740, the system will analyze the user's response and determine which alternate processing is needed.

At the decision box numbered 740, the system checks a count of the number of mistakes in the user's response that is currently being analyzed. If the user has made an error, but less than a predetermined number of errors are identified, then the user will repeat the just-completed exercise. FIG. 7B shows that the predetermined number may be, for example, three errors. The predetermined number of errors is selected by the designer of the language instruction system. This processing is indicated by the “<3” response leg from the decision box 740 and box 742, which indicates system processing to repeat training on the current word or phrase as comprising a return to box 712 of FIG. 7A. If the user has not made any error in the spoken response, indicated by the “0” response leg from the decision box 740 and box 744, then the user will select a new phrase or exercise drill (box 746) and will proceed to the next step or exercise in the lesson. FIG. 7B indicates that, in this processing, the system returns to box 706 of FIG. 7A. If the user has made three or more errors for the same exercise, the “>3” response leg, then the system will refer the user to work on a specific problem by directing the user to exercises in which the user will receive extra training on the specific problem, as indicated by the diagram box 748, and the user will then repeat the exercise in which the user erred (box 750) will then be repeated. The processing after box 750 will return to box 712 of FIG. 7A. Only when the user has answered the exercise correctly will the user be able to continue to the next exercise in the lesson.

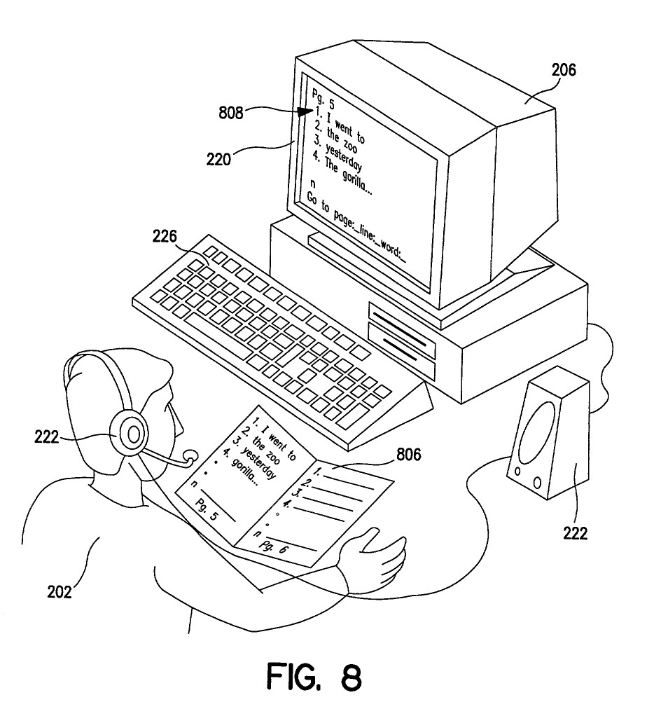

The system, as described above, may be configured according to FIG. 2 so that a system server and the user PC are connected to the Internet. Thus, the system can accommodate multiple simultaneous users, such as the user 202 depicted in FIG. 3A, 3B seated in front of a PC 206. As illustrated in FIG. 8, the user 202 is seated at the PC computer 206 and receives, through the display screen 220, or the speaker or headphones 222, the exercises to be studied, via speech and/or graphics presentation. The user follows along in a reader, or workbook, or other material 806 that provides a set of exercises and instructional material. The user then responds either by speaking into the microphone or by using the keyboard or the display mouse or other input device 226. The user selects a particular page of the reader and the text on the screen is identical to the text in the book version of the reader. FIG. 8 shows a sample exercise 808 being presented to the user 202, with page and line numbers being indicated on the PC display screen and a navigational command line 810 appearing at the bottom of the PC display.

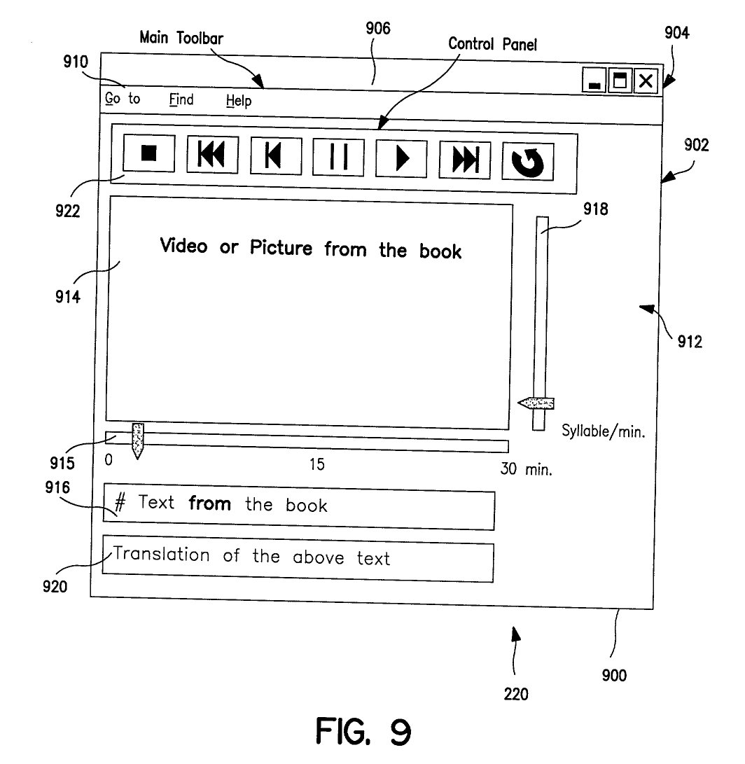

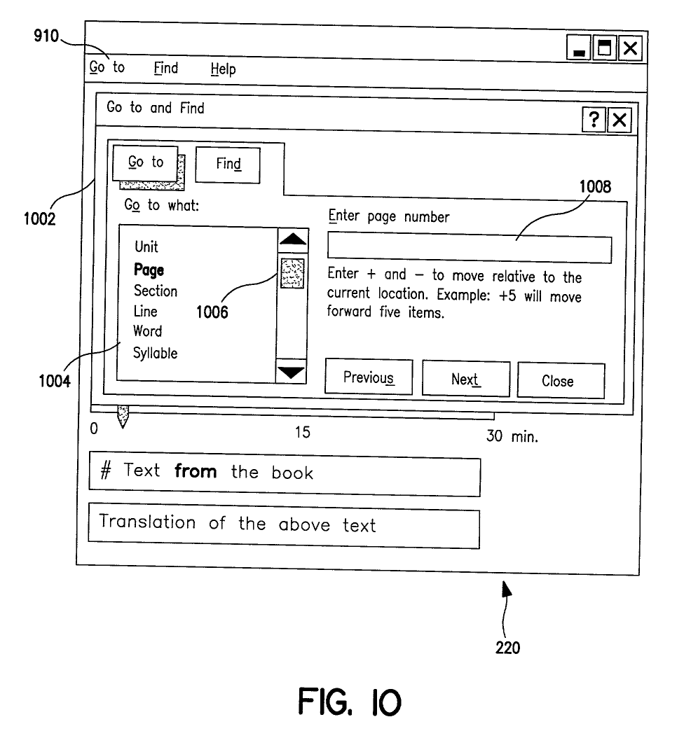

FIG. 9 is a representation of the window display 900 produced by the user's PC 206 of FIG. 8 which, as noted above, preferably provides language skills exercises with window displays in accordance with a graphical user interface. Therefore, the window display 900 includes typical window interface artifacts, such as a window frame 902 with window sizing icons 904 and a title bar 906. A main toolbar 910 includes menu items such as “Go To”, “Find”, and “Help”, which activate drop-down menus or sub-windows for operation of their respective functions. Those skilled in the art will be familiar with drop-down menus.

A workspace area 912 beneath the main toolbar 910 is an area where the language skills audiovisual training materials are displayed to the user. Thus, a video, picture, or animation is presented on the display screen in a visual window 914. A text window 916 contains a “printed version” of the screen display 914. The “printed version” may comprise, for example, a scrolling transcript or captioning of spoken narration that accompanies the presentation of exercises, or may comprise a description of the images being presented in the visual window. The user can alter the difficulty of the exercises being presented to the user by adjusting a display slider 918. As the slider is moved, the system changes the level of exercises presented to the user. The changes may comprise, for example, determining whether or not the displayed text 916 can be translated into the user's native language and displayed in a translation text window 920. Lower levels of difficulty will allow for display of a translation to assist the user.

The user may receive instructions and messages from the system in the user text window 920. The user may respond to a question or message by recording a spoken answer, or by selecting graphics or text, or by spelling a phrase into the visual window 914. The user may control the presentation in the visual window 914 by manipulating a navigation bar 922 in the workspace area 912. Thus, the user may select display buttons on the navigation bar to stop the presentation, pause it, initiate playback, and move forward and backward.

FIG. 10 shows the window display that is produced when the user selects the “Go To” menu button on the tool bar 910. The system responds by presenting a Go-To window 1002, in which the user may specify either a video image or picture from the accompanying book (FIG. 8) and/or by selecting a particular page of the book. The Go-To window 1002 may appear on the display on top of the window shown in FIG. 9. The user's selection is indicated in FIG. 10 by boldface type (there is no boldface type in FIG. 10). The Go-To window 1002 includes a scrolling menu box 1004 from which a user may select a choice from among a list, either by using the PC keyboard cursor controls or display mouse, or by moving a scrolling button 1006, in a manner known to those skilled in the art.

More particularly, the language skills training system permits the user to skip to a particular place in the audio track that accompanies the presentation of the exercise. The user may use the menu box 1004 to select a particular unit, page, section, line, word, or syllable by citing the appropriate location in the accompanying printed material. The user selects the particular location (for example: a page) and enters the location number in a location text window 1008. Alternatively, the system offers a relative navigation scheme where the user specifies the units being used by selecting from the menu box 1004 and by specifying a number of units (unit/page/section/line/word/syllable) together with a “+” or “−” sign to indicate moving forward or backward the number of specified units. For example, entering “page” from the menu box 1004 and entering “+5” in the location window 1008 will cause the system to move the presentation in the window 912 (FIG. 9) forward by five pages.

FIG. 11 shows the window display that is produced when the user selects the “Find” menu button on the tool bar 910. The system responds by presenting a Find window 1102, in which the user may specify a search to the user to skip to a particular phrase (such as a sentence, word, or syllable) in the audio track that is produced during playback, according to content in the accompanying printed materials. The user may specify a search direction relative to a present location in the audio playback, either beginning the search with the present location and moving down from there (backward), from the present location up (forward), or searching through the entire exercise or presentation. The user may specify a search direction choice by selecting from a scrolling menu box 1104 or moving a display slider 1106.

In addition, the particular text can be entered by the user in a search text window 1108 and will be found by the application. The user can enter text to find the entered text itself, in the target language of the exercise, or can enter text into the window 1108 to find a translation of the text (translated into the user's native language). In accordance with conventional computer search command navigation, the system permits a user to move from instances of found search terms by selecting from a “Previous” display button 1110 and from a “Next” display button 1112, or the user can cancel searching and close the “Find” window 1102 by selecting a “Cancel” display button 1114.

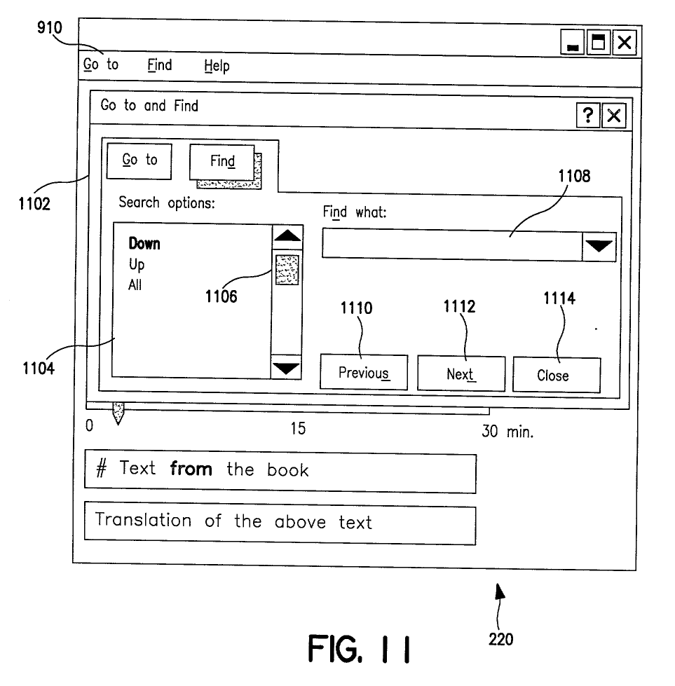

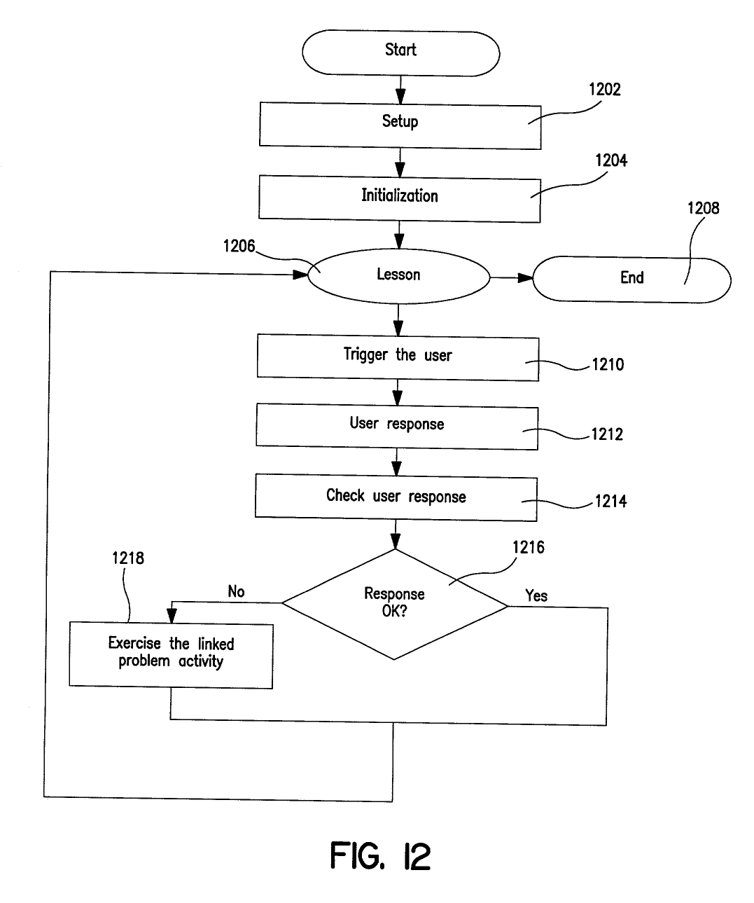

FIG. 12 is a flow diagram that illustrates the processing executed by the FIG. 8 computer system to perform context-based language instruction with language work book materials. In the first operation, the user sets up the language skills training system and begins the lesson, as indicated by the flow diagram box numbered 1202. The setup operation may include, for example, user identification and registration. The system then performs an initialization operation at box 1204, such as setting error counts and lesson tracking data to initial values. Next, at box 1206, the system presents a lesson to the user in accordance with the user's progress in the lesson plan. If the user has completed all exercises, then the system ends the presentation at box 1208. In an exercise, the user may be presented with a language exercise trigger event, such as audio, graphics, or other audiovisual material that requests a response from the user. This is indicated at the flow diagram box numbered 1210.

The user responds to the trigger event at box 1212 by providing a text response, selecting from a list or image, and/or speaking into the PC microphone. At box 1214, the user's response is checked. In the preferred embodiment, the user's response is checked against correct responses stored in the reference database (FIG. 7B). A user spoken response may be analyzed in accordance with the spoken phrase parameters extraction operations described above in conjunction with FIG. 7A and FIG. 7B, such as segmentation, phonetics, pronunciation, stress, rhythm, and intonation. At the decision box 1216, if no error is found in the user's response, an affirmative outcome, then the user is directed to a new activity or exercise by returning the processing to the lesson box 1206. If the user's response is determined not to be free of error, a negative outcome at the decision box 1216, then at box 1218 the user is referred to, or automatically linked to, a problem activity and training exercise where the user will receive additional training on a skill indicated by the error or errors.

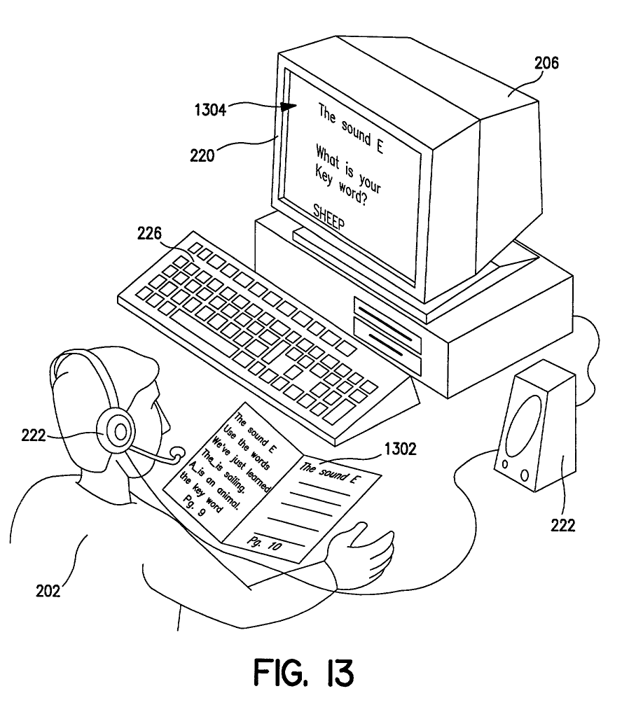

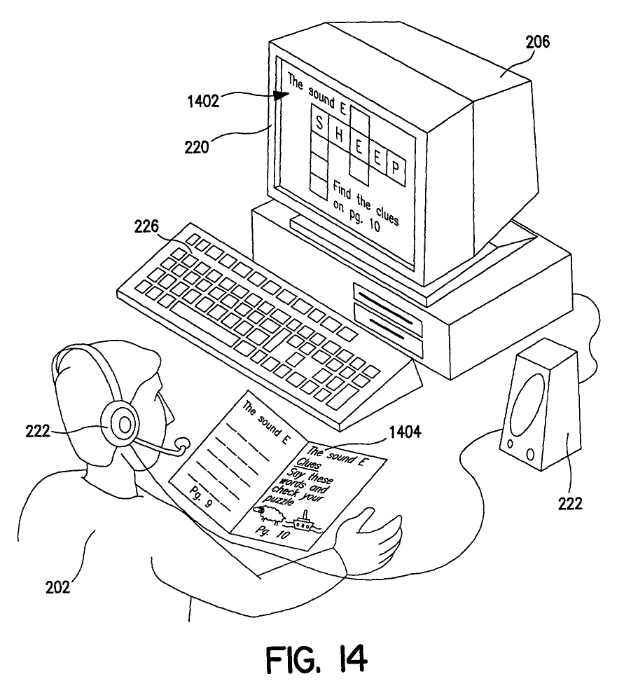

FIG. 13 and FIG. 14 are graphical representations of the language skills training computer illustrated in FIG. 8 being used in conjunction with printed materials 1302 as described above. FIG. 13 shows a user 202 seated before the PC 206 and being presented with a display screen 220 that shows a language skills training exercise 1304 for the English language. Both the computer display 220 and the printed materials 1302 show that the title of the exercise is “The sound E” . Thus, the exercise being presented to the user will provide the user with grammar and language skills questions that will give the user training in pronouncing the “E” sound. For example, the workbook 1302 indicates that the user will be asked to properly use words just learned, such that the user's pronunciation of such words will also be checked. FIG. 13 indicates that, at page 9 of the printed materials 1302, the user is asked to produce a keyword to complete two sentences, the first sentence indicated as “The ______ is sailing.” and the second sentence indicated as “A ______is an animal.” It should be noted that the exercise 1304 shown on the computer display 220 is not identical to the text that appears in the printed material 1302. The computer display material 1304 only asks for the user's response. The user will provide a spoken response by speaking into the PC microphone 226.

FIG. 14 shows a user 202 seated at the PC 206 and being presented with another language training exercise 1402 on the computer display 220. In this alternative type of exercise shown, the user is asked to vocally produce a particular word by looking at the printed material 1404 for clues and instructions. FIG. 14 shows that clues are given to the user at page 10 in the printed materials for use with a crossword puzzle 1402 that is shown on the computer display 220. If the system detects a correct spoken response from the user, it will insert the correct word in the correct location of the display puzzle 1402. If the user produces the word incorrectly, the word will not appear in the puzzle.

Assessment Tool

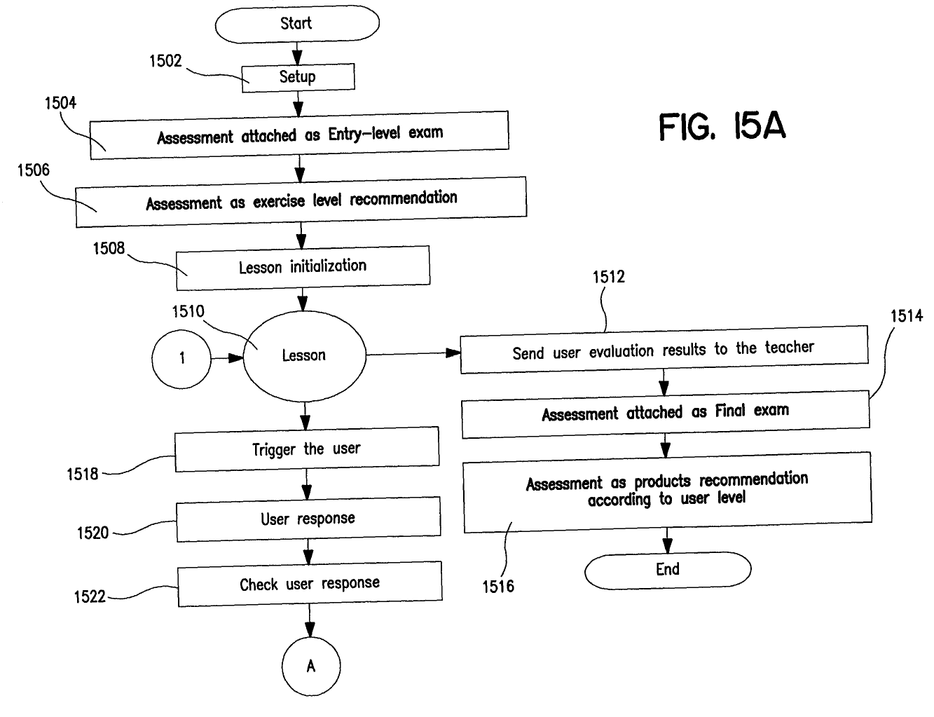

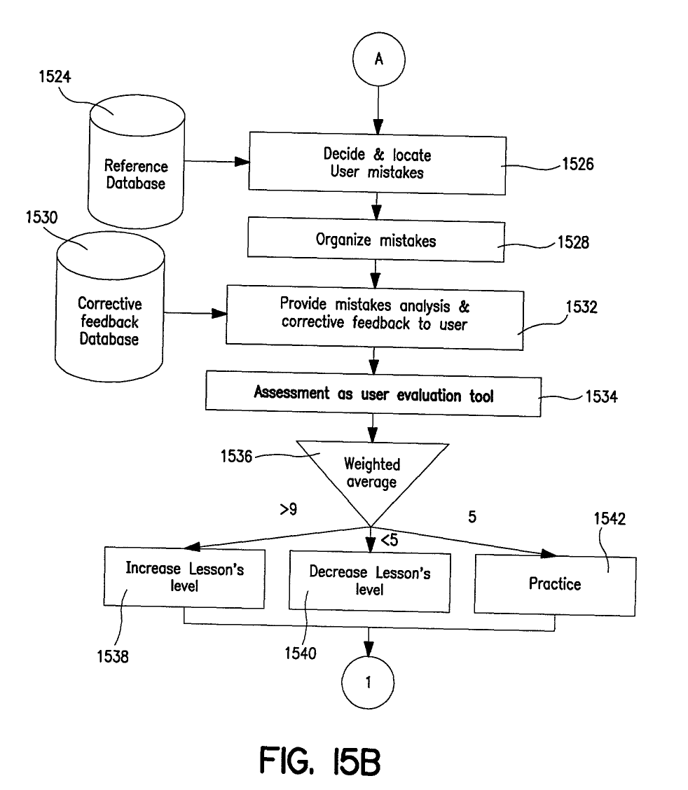

FIG. 15A and FIG. 15B together provide a flow diagram that illustrates the operation of the language skills training system to include an assessment tool. The assessment tool feature of the system can be used in a variety of ways. For example, the assessment tool can be used at the beginning of a lesson, or it can be used at the end of the lesson. Using the assessment tool at the beginning of a lesson will help determine the exercise level at which the user will receive instruction. Using the assessment tool after corrective feedback has been presented permits the tool to be used to alter the level of the lesson to suit the user's demonstrated abilities. Thus, using the assessment tool at the end of a lesson can be similar to a student taking a “final exam” in a school curriculum and can also be a means of recommending other products that might be suitable to the particular user's language skills level. The assessment tool preferably comprises a test of the language skills being presented in a given exercise or lesson plan.

As explained above for other system features, the user begins using the system by progressing through a setup operation, indicated by the FIG. 15A flow diagram box numbered 1502. The next box 1504 represents invoking the assessment tool before the lesson, using the assessment skills test to determine the exercise at which the user will be placed for beginning instruction. The flow diagram box numbered 1506 represents invoking the assessment tool skills test before an exercise. This operation 1506 uses the skills test as a difficulty-setting examination to recommend an exercise level of difficulty for the user. The user then starts up the system and the lesson is initialized, as indicated at box 1508. At box 1510, the user begins practicing the exercises and responding to the system.

During the progress of a lesson, each lesson exercise or problem will comprise a trigger to the user for the submission of a response. This is indicated at the box numbered 1518. Next, at box 1520, the user response is received. At box 1522, the user response is checked and analyzed. The user response is compared to the reference database at box 1524 (FIG. 15B) and at box 1526 the mistakes, if any, are located. At box 1528, the mistakes are organized by the system according to the type of error (e.g., pronunciation, stress, intonation, etc.). The system, linked to the corrective feedback database at box 1530, and then at box 1532 the system provides the user with an analysis of the mistakes and an explanation of corrective actions by which the user may correct the errors. The assessment tool will automatically perform a user evaluation at box 1534, considering the number and type of errors made by the user to determine a user level.

Based on the user results and the assessment at box 1534, the system determines the proper lesson level for the user by calculating a weighted average of the results, considering the user responses to the problem exercises (box 1536). For example, if the user has an assessment calculation greater than a predetermined value, indicated in FIG. 15B by the path “>9”, then at box 1538 the system will increase the difficulty level of the lessons. If the user has an assessment calculation less than a predetermined level, indicated in FIG. 15B by the path “<5”, then at box 1540 the system will decrease the lesson difficulty level. At an intermediate assessment level, indicated by “5” in FIG. 15B, the system will determine that the user would benefit from additional practice, indicated at box 1542. The user will then be directed to additional exercises, returning to the lesson presentation schedule at box 1510 of FIG. 15A.

At the end of a lesson, which comprises a group of individual problems or exercises that require user response, the system sends user evaluation results to the instructor or teacher under whose direction the user is receiving instruction. This is represented by the FIG. 15A flow diagram box numbered 1512. Once all the lessons are completed, the assessment tool may be used as a final examination where the assessment results are sent to a teacher, as indicated at box 1514, and at box 1516 the assessment results may be used as a means of offering and recommending additional products to the user, suitable to the user's level.

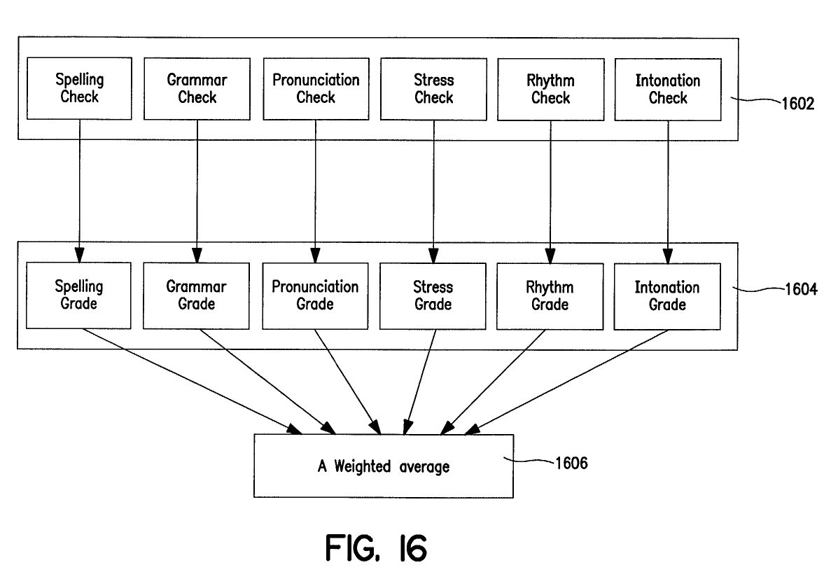

FIG. 16 shows additional details of the system. More particularly, the assessment tool checks various aspects of the user's performance including spelling, grammar, pronunciation, stress, rhythm, and intonation. These operations take place regardless of whether the assessment tool is used as a user evaluation tool (box 1534 of FIG. 15B) or as a “final exam” tool (box 1514 of FIG. 15B). FIG. 16 illustrates the sequence of operations performed by the assessment tool. Block 1602 shows the operations of checking the user's response for spelling, grammar, pronunciation, stress, rhythm, and intonation. Each aspect of the user's response is given a grade, indicated by block 1604, and then the grades are averaged or weighted, indicated at block 1606, resulting in a weighted grade of the user's performance. In particular, the weighted grade may be used at the decision box 1536 to make adjustments to the lesson difficulty.

Conversation Aid

Another feature that may be provided in accordance with the language skills system constructed in accordance with the invention is a “Conversation Aid” tool. The Conversation Aid supports a guided multi-party conversation or dialogue, where each participant in the conversation is presented with text or supportive material that guides the dialogue. The conversation may occur, for example, between users at the same computer or at different computers located over a LAN or WAN, or may occur between various users who communicate (who provide their contributions to the dialogue) over the Internet, or between individual users and the public switched telephone network (PSTN), or the conversation may occur between an individual user and a computer itself (wherein the Conversation Aid itself acts as the other dialogue participant).

Using the Conversation Aid, each participant in the conversation may independently or simultaneously control the speed with which he or she listens to, or is presented with, dialogue from the other side. That is, the bi-directional or two-way conversation (as through a PC-based telephone) allows each side to select and control the speed of the received sound. This feature permits each of the users to adjust presentation speed to suit their individual comprehension level. In this way, the Conversation Aid can be used to provide a “Voice Friend” service that may help match individuals together based upon, among other criteria, the users'spoken language skills levels.

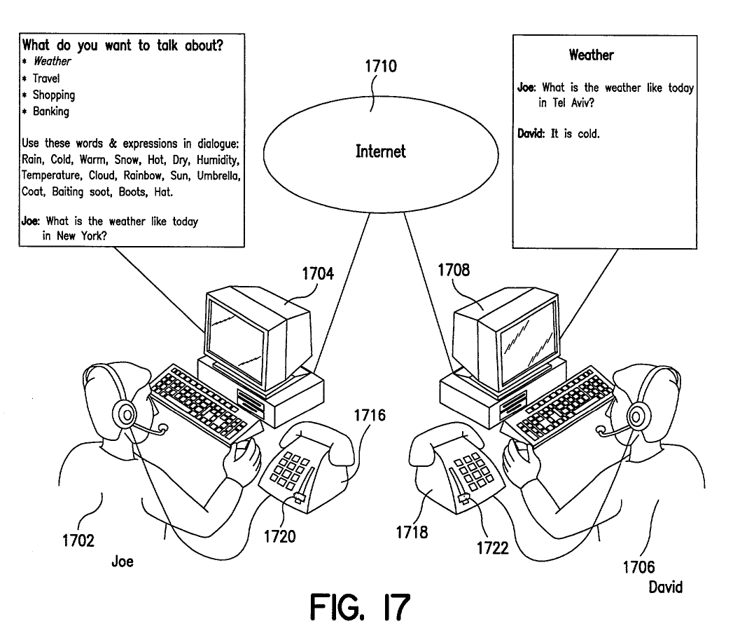

FIG. 17 illustrates the operation of the Conversation Aid tool. FIG. 17 shows a situation in which a first user 1702 at a first language skills training computer 1704 is participating in a conversation with a second user 1706 at a second language skills training computer 1708 by communicating over the Internet 1710. The Conversation Aid generates appropriate display messages on the display screens of the two computers 1704, 1708. As shown in FIG. 17, the Conversation Aid generates displays that ask the users to choose a topic of conversation and then helps them converse with one another. For example, the first user 1702 is presented with a question as to desired conversation topic, being offered topics such as the weather, travel, shopping, and banking. The Conversation Aid provides suggestions for facilitating the conversation while learning language skills, such as the illustrated suggestion for using particular vocabulary words. At the first computer 1704, the first user 1702, identified as “Joe”, provides input. The dialogue provided by Joe is a question, “What is the weather like today in New York?”

FIG. 17 shows that the language skills learning system at the second computer 1708 receives Joe's input from the Internet and provides the user dialogue input from Joe, so that the second computer display shows the dialogue “Joe: What is the weather like today in New York?” FIG. 17 shows the response from the second user 1706, who is identified as “David”: “David: It is cold.”

FIG. 17 shows that each user is connected to the Internet via a telephone connection 1716, 1718. Each telephone 1716, 1718 is configured so it includes a slider mechanism 1720, 1722. Each of the users 1702, 1706 may use their respective sliders 1720, 1722 to adjust the speed of the conversation they are receiving. The adjustment may comprise, for example, a control input from the slider to the language skills computer that causes the computer to temporarily store information packets in memory before the packets are converted to dialogue and are provided to the respective user.

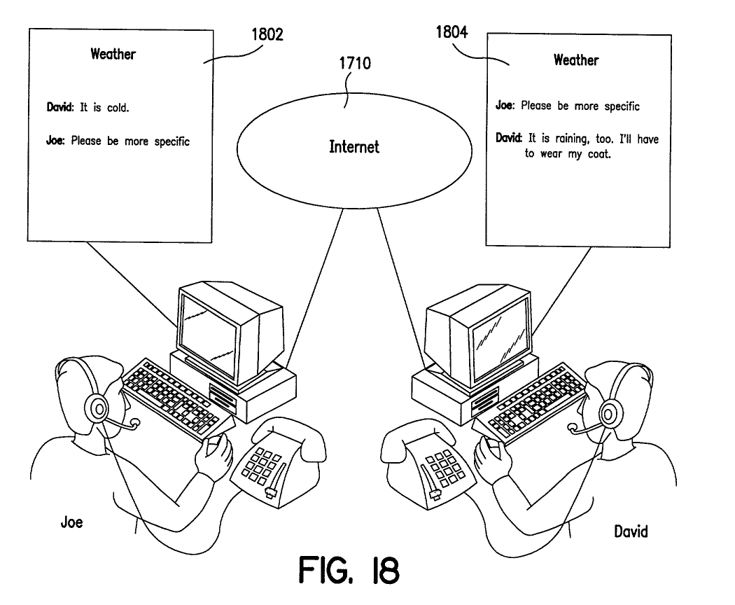

FIG. 18 shows a continuation of the dialogue that was begun in FIG. 17, indicating in block 1802 that user “Joe” has responded as follows: “Joe: Please be more specific.” In block 1804, the computer display of user “David” repeats the answer from user “Joe”, and also shows the response from user “David”: “It is raining, too. I'll have to wear my coat.”

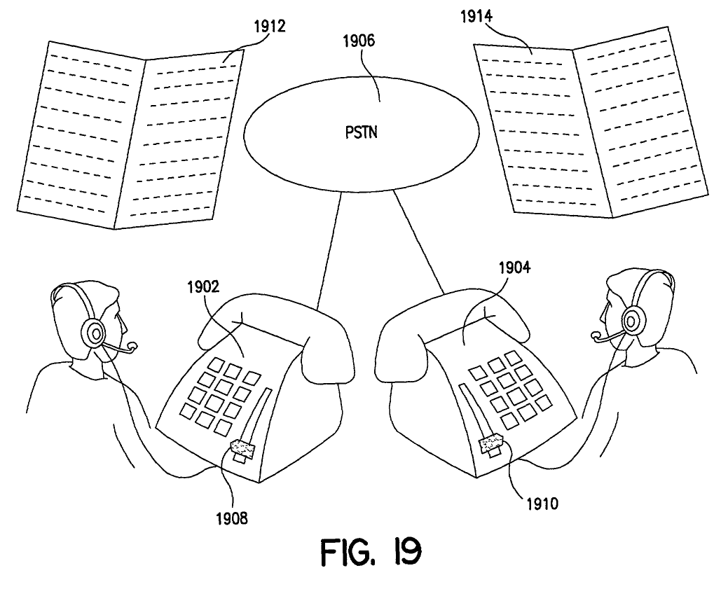

FIG. 19 shows that the Conversation Aid can be implemented with telephones 1902, 1904 over the public telephone network (PSTN) 1906. In such a configuration, the telephones have their respective conversation speed sliders 1908, 1910 that adjust the speed of conversation. As noted above, the adjustment may be implemented with buffers for temporary storage of dialogue information from each participant. FIG. 19 also shows that the Conversation Aid may also be used in conjunction with supporting material at one or both users, such as a printed workbook 1912, 1914.

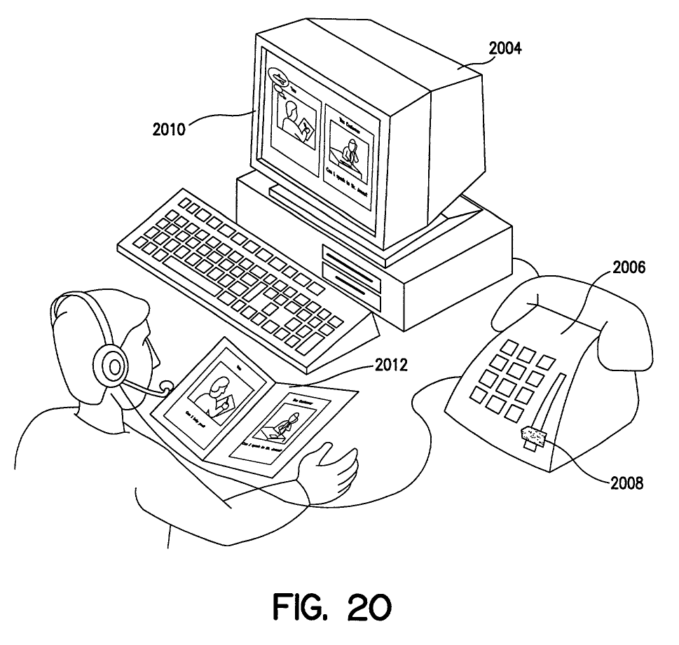

FIG. 20 shows the Conversation Aid language skills training system being operated by a user 2002 as a Conversation Aid, where the second dialogue participant is a computer 2004. FIG. 20 shows that the user communicates with a distant computer via a telephone connection, using a telephone 2006 having the slider speed adjustment 2008 as described above. The Conversation Aid illustrated in FIG. 20 generates a question or other trigger that asks the user for a response, such that the trigger is shown on the display 2010 of the computer 2004. The user will respond vocally to the displayed trigger, preferably speaking into a microphone of the computer (FIG. 2). The Conversation Aid may display answers from the user 2002 on the computer display. Thus, the user 2002 converses with the Conversation Aid computer 2004. As noted above, the user can adjust the speed of the conversation with the computer using the slider mechanism of the telephone. As illustrated in FIG. 20, the user may be presented with supplemental materials, such as a booklet 2012 in printed form.

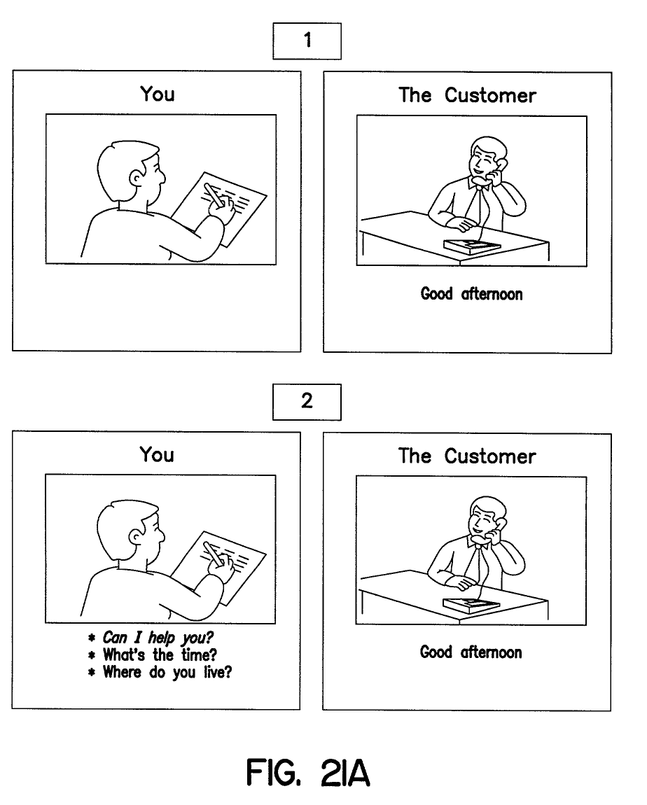

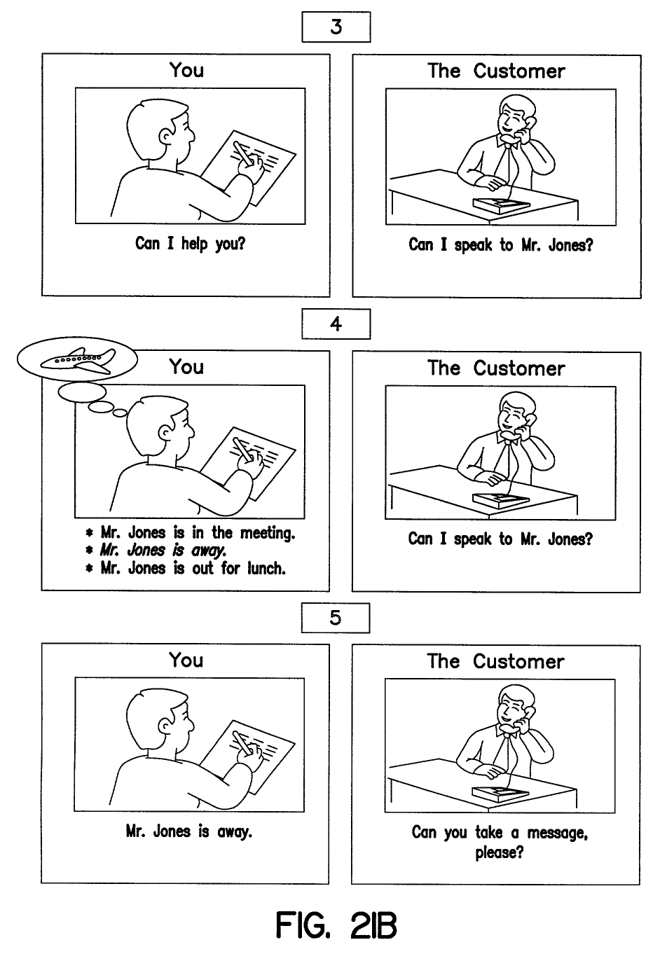

The Conversation Aid feature of the FIG. 20 system is further illustrated in FIG. 21A and FIG. 21B, which illustrates a sequence of dialogue between a user and a computer Conversation Aid. In the illustrated sequence, the human user is identified as “You” in the left pane of each dialogue sequence. The computer response is illustrated in the right pane of each dialogue sequence. The illustrated dialogue is an example of a guided dialogue or guided conversation, in which the user is asked to repeat a selected phrase as the user's response. Thus, the computer may guide the conversation such that the user may be given practice in areas suggested by the Assessment Tool, or suggested by some other means of selecting exercises.

For example, the first pair of dialogue illustrations, labeled “1”, shows the user (“You”) preparing to interact with the Conversation Aid, which prompts the user with a trigger statement (“Good afternoon”). In the second pair of dialogue panes (2), the computer prompt is shown again in the right pane, and the left pane is shown with alternative responses provided to the user, which are shown as “Can I help you?”, “What's the time?”, and “Where do you live?”. The response alternative of “Can I help you?” is shown in italics, to indicate that the user should repeat that response.

The next pair of dialogue panes, labeled “3” in FIG. 21B, shows the user vocalizing the response, “Can I help you?”, along with the Conversation Aid response, which is shown as “Can I speak to Mr. Jones?” The next pair of panes (“4”) shows a trigger group of questions that are presented to the user. The list of questions includes “Mr. Jones is in a meeting.”; “Mr. Jones is away.”, and “Mr. Jones is out for lunch.”The italics for the phrase “Mr. Jones is away.” indicates that this response is desired from the user. The next sequence (“5”) shows the user response, which is shown in the left pane. As noted above, the user speaks the response into the computer microphone, and the language learning skills computer converts the received response into text that is shown on the computer display. The right pane shows the next trigger phrase from the computer, showing that the computer continues the dialogue.

Thus, a language training system constructed in accordance with the present invention supports an interactive dialogue with a user who is receiving training in a target language. The system also provides an interactive system that includes multiple context-based practice exercises and multiple problem-based exercises, such that each problem-based practice exercise is interactively linked to at least one of the context-based practice exercises, and relates to skills being practiced in the context-based practice exercises to which it is linked, and wherein each context-based practice exercise tests user skills that are being taught in the linked problem-based exercises. If the user responses indicate that the user would benefit from extra practice in particular types of language skills, then the user will be routed to one or more practice problem sets that involve the language skills in which the user is deficient. Upon successful completion of the problem sets, the user is returned to the exercise sequence, either to the same exercise, prior to the problem set, or to the next exercise in the lesson plan sequence.

The present invention has been described above in terms of a presently preferred embodiment so that an understanding of the present invention can be conveyed. There are, however, many configurations for language training systems not specifically described herein but with which the present invention is applicable. The present invention should therefore not be seen as limited to the particular embodiments described herein, but rather, it should be understood that the present invention has wide applicability with respect to language training generally. All modifications, variations, or equivalent arrangements and implementations that are within the scope of the attached claims should therefore be considered within the scope of the invention.

I claim:

1. An interactive instruction system comprising:
a plurality of context-based practice exercises that may be presented to a user by a presentation device; and
a plurality of problem-based exercises that may be presented to the user by the presentation device;
wherein each problem-based practice exercise is interactively linked to at least one of the context-based practice exercises, and relates to skills being practiced in the context-based practice exercises to which it is linked, and wherein each context-based practice exercise tests user skills that are being taught in the linked problem-based exercises.

2. A system as defined in claim 1, wherein the system directs the user to one or more of the problem-based exercises in accordance with the user's performance in an assessment that tests user skills being taught in a context-based exercise.

3. A system as defined in claim 1, wherein user skills being taught in the context-based exercises relate to spoken language skills.

4. A presentation system comprising:
a presentation component that performs playback of presentation material comprising a sequence of audio or audiovisual material having a text transcript that corresponds to the content of the presentation material being played; and
a navigation subsystem that receives a user command to change the playback of the presentation material in accordance with a location in the text transcript.

5. A presentation system as defined in claim 4, wherein the presentation material includes printed material that provides a duplication of the text transcript.

6. A presentation system as defined in claim 4, wherein the user command specifies a destination location in the text transcript for playback that is specified relative to a present location in the text transcript.

7. A presentation system as defined in claim 4, wherein the user commands specify a destination location in the text transcript for playback that is specified in written text units comprising one or more of words, sentences, paragraphs, or pages of the text transcript.

8. A presentation system as defined in claim 4, wherein the user commands specify a playback speed for the presentation component in accordance with a user comprehension level.

9. An instruction system comprising:
a presentation application program that presents language material to a user, wherein the language material includes words in a target language; and
a dictionary application program that responds to user selection of words contained in the language material by producing corresponding word definitions;
wherein at least one of the words in the language material is a word having multiple alternative definitions, and wherein the system responds to user selection of the multiply defined word by presenting one of the multiple definitions, in accordance with the context in which the selected word appears in the language material.

10. An electronic book comprising material that defines a work of authorship for playback on a playback device, wherein playback of the electronic book on the playback device provides a presentation of the work of authorship and provides a presentation of a transcript corresponding to the work of authorship, and wherein the playback device communicates with the user to support interactive spoken language skills instruction in conjunction with playback of the work of authorship.

11. An electronic book as defined in claim 10, wherein the spoken language skills instruction relates to spoken vocabulary.

12. An electronic book as defined in claim 11, wherein the spoken language skills relate to spoken vocabulary and wherein the playback device communicates with the user to support interactive spoken language skills instruction in conjunction with playback of the work of authorship.

13. An electronic book as defined in claim 10, further including:
a plurality of context-based practice exercises that may be presented to a user by the playback device; and
a plurality of problem-based exercises that may be presented to the user by the playback device;
wherein each problem-based practice exercise is interactively linked to at least one of the context-based practice exercises, and relates to skills being practiced in the context-based practice exercises to which it is linked, and wherein each context-based practice exercise tests user skills that are being taught in the linked problem-based exercises.

14. An electronic book as defined in claim 13, wherein the context-based practice exercises are interactively linked to phrases contained in the work of authorship, and the context-based exercises relate to phonetics.

15. An electronic book as defined in claim 13, further including reference to context-based practice exercises and problem-based exercises that are contained in a printed work.

16. An electronic book as defined in claim 13, further including written material that includes indications for navigation.

17. An electronic book as defined in claim 10, further including:
presentation material comprising a sequence of audio or audiovisual material for playback on the playback device, the presentation material having a text transcript that corresponds to the content of the presentation material being played; and
a navigation subsystem that receives a user command to change the playback of the presentation material in accordance with a location in the text transcript.

18. An electronic book as defined in claim 10, wherein the presentation material includes printed material that provides a duplication of the text transcript.

19. An electronic book as defined in claim 10, wherein the user command specifies a destination location in the text transcript for playback that is specified relative to a present location in the text transcript.

20. An electronic book as defined in claim 10, wherein the user command specifies a destination location in the text transcript for playback that is specified in written text units comprising one or more of words, sentences, paragraphs, or pages of the text transcpript.

21. An electronic book as defined in claim 10, wherein the user command specifies a playback speed for the presentation component in accordance with a user comprehension level.

22. A system that supports interactive dialogue, the system comprising:
a voice recorder that records a spoken user input; and
a response analyzer that analyzes the spoken user input for multiple spoken language skills criteria, wherein at least one of the criteria comprises intonation, stress, or rhythm.

23. A system as defined in claim 22, wherein the response analyzer provides the user with corrective feedback that indicates to the user what the user must accomplish to correct the phonetic mistakes in the target language.

24. A method of providing interactive language skills instruction, the method comprising:
providing a plurality of context-based practice exercises that may be presented to a user by a presentation device; and
providing a plurality of problem-based exercises that may be presented to the user by the presentation device;
wherein each problem-based practice exercise is interactively linked to at least one of the context-based practice exercises, and relates to skills being practiced in the context-based practice exercises to which it is linked, and wherein each context-based practice exercise tests user skills that are being taught in the linked problem-based exercises.

25. A method as defined in claim 24, further including
providing an assessment that tests user skills being taught in a context-based exercise; and
directing the user to one or more of the problem-based exercises in accordance with the user's performance in the assessment.

26. A method as defined in claim 24, wherein directing comprises directing the user to one or more of the problem-based exercises in accordance with the user's performance in the user skills tests of a linked context-based practice exercise.

27. A method as defined in claim 24, wherein user skills being taught in the context-based exercises relate to spoken language skills.
